(19) United States
(12) Patent Application Publication
(10) Pub. No.: US 2002/0138303 A1
(43) Pub. Date: Sep. 26, 2002

(54) Method and apparatus for personalized medical prescription services

(76) Inventors: Gil Enos, Issaquah, WA (US); Marc Lilly, Seattle, WA (US)

Correspondence Address: David A. Hall, Heller Ehrman White & McAuliffe LLP, 7th Floor, 4350 La Jolla Village Drive, San Diego, CA, 92122-1246, US

(21) Appl. No.: 10/005,695

(22) Filed: Nov. 7, 2001

Related U.S. Application Data
(60) Provisional application No. 60/246,826, filed on Nov. 8, 2000.

(51) Int. Cl. G06F 17/60

(52) U.S. Cl. 705/2

(57) ABSTRACT

A formulary for a physician is placed in a data store and a personalized, physician-specific prescription pad is generated using the stored formulary, thereby enabling physicians to comply with formularies, for example, set by their medical group (MG) or indirectly by their insurance group (IG). The prescription pads may be created taking into account several factors, such as the formulary established by the physician's MG or indirectly by the insurance groups of patients seen by the physician (or based on the physician's patient panel) or by the MG in general, the physician's practice area, the efficacy of drugs, rebates from pharmaceutical companies, the drugs most likely to be approved by the insurance groups of the physician's or MG's patient base or panel, prescribing habit of the physician, drugs most frequently prescribed, and the like. From such factors a physician-specific formulary or list of drugs is determined, from which the system creates the physician-specific prescription pads. The prescription pads are typically contained in a prescription services system that optionally includes other features such as a web site portal enabling users of the prescription services system to enter and view information, a service that alerts the appropriate user that previously generated prescription pads should be updated and alerts the physician regarding information about drugs listed in their prescription pads, a database repository as well as a system that merges, collects, and stores information, and an analyzer that performs prescription service analyses and generates reports accordingly.

This application claims priority of co-pending U.S. Provisional Patent Application Serial No. 60/246,826 entitled “Method and Apparatus for Personalized Medical Prescription Services” filed Nov. 8, 2000. Priority of the filing date of Nov. 8, 2000 is hereby claimed, and the disclosure of said Provisional Application is hereby incorporated by reference.

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

1 Field of the Invention

The present invention relates generally to the field of medical prescriptions, and more particularly to systems and methods facilitating physician prescription and formulary compliance.

2. Description of the Related Art

In the increasingly complex healthcare environment of today, one thing is painfully clear: As advanced as the science of medicine may be, the administrative aspects of the profession lag far behind the technological curve. At the front line of healthcare—the physician's office—where the greatest number of patient interactions occurs, also exists the greatest amount of administrative paralysis. This is primarily due to the lack of effective technological solutions and the fragmentation of the healthcare marketplace. Nowhere is this more evident than in the prescribing process of today's physician.

Prescription medicine is the fastest growing segment of health care and the least managed. In fact, upwards of 50% of problem calls into a doctor's office today are pharmacy-related. See “Merck-Medco” Study as presented at the AAHP 2000 Conference, June 2000. Consider the fact that physicians still write prescriptions by hand-nearly 2.5 billion of them just last year alone. NACDS 1999 Retail Drugstore Report, 2000. (There are 900,000 physicians in the U.S., and 600,000 of these doctors prescribe drugs during the course of their busy days. This represents over 2.5 billion prescriptions written annually.) For better or worse, healthcare has changed, but the clinician has not.

Many companies have endeavored to develop specialized hand-held prescription writing devices and applications for physicians that will provide them with relevant patient and health plan-specific information at the time of prescribing; but very few physicians, less than 2%, have actually adopted them. Time, money and a lack of training are the primary reasons for this. For example, some of these hand-held prescription devices/applications require physicians to enter patient information before they can even write the patient's prescription. This usually takes two to four minutes of a physician's valuable time. Furthermore, physicians lack the time to use these cumbersome devices considering that doctors today spend an average of only seven minutes per visit with each patient. They also cannot afford the high cost of the solutions; and, in most cases, do not have an interest in learning about new technology, mainly due, again, to time constraints. Many of these leading electronic prescribing application companies today, for example, also charge $250 per month ($3,000 per year), per physician. Furthermore, many of these applications and devices do not take into account physicians' prescribing habits and information relevant to each physician. As a result, a $120 billion annual market is administrated in a low-tech, manual fashion, i.e., by hand-written prescriptions.

An even more serious byproduct of this issue is that a large percentage of the 2.5 billion prescriptions written are illegible, and are then easily confused with like-sounding drugs (“Zoloft” vs. “Zyrtec”, for example), which may be for different treatment indications. These errors only serve to compound the problem and can have potentially deadly consequences. Considering all these factors, it is clear that the healthcare industry needs a solution to the fast-growing problem of prescription medication management.

Another problem faced by health care industry is fraud. Sheets from prescription pads are sometimes stolen, and are then illegally copied and used to purchase unprescribed drugs. This kind of fraud is costing the industry $25 billion a year.

Market Opportunity

The fastest growing component of healthcare expenditures is pharmaceuticals, totaling over $100 billion per year in 1998, and representing over 8% of total healthcare dollar. In addition, pharmaceutical costs are expected to increase at about 10% per year through 2007, driven by an aging population, as well as the accelerating introduction of new drugs and aggressive direct-to-consumer advertising by pharmaceutical manufacturers. See HCFA Report on Medical Expenditures, 1999.

It has been reported that there are over 690 health plans and 120 PBMs in the U.S. today. See “Pharmacy Benefit Report”, Facts and Figures, Novartis, 1999. As a result, 80% of the individuals in a typical physician's patient panel or customer/patient base (the average size of which is 2,000 active patients) are enrolled in a managed care plan and have a corresponding pharmacy benefit (or MCO formulary) for that plan. Compounding this situation, unfortunately, the typical physician's patient base is represented by anywhere from 10 to 20 different MCOs (PBMs), resulting in as many as 30 to 40 different formularies that the physician is expected to, but does not, manage effectively. These MCO formulary guides are presented to physicians in book form and updated frequently throughout the year, via mailed updates. With today's time-pressed physician, there is insufficient time to wade through these guides during the seven minutes a physician may spend with a patient. In fact, a physician typically makes a prescribing decision without referring to the appropriate formulary guide, and then hopes that the prescribed drug will not be rejected by the MCO. This, in turn can set off a chain of time-wasting events that overly burdens the physician, the pharmacist, and the MCO, and results in a frustrated, inconvenienced, and often under-served patient. This indicates a need for change in providing prescription services.

An October 2000 report by W.R. Hambrecht & Co., entitled “The Cure is In Hand: Bringing Information Technology to Patient Care,” reported that MCOs would pay between $.75 and $1.50 per plan-verified prescription-due to the fact that there is such great value in ensuring appropriate formulary compliance. As pharmaceutical costs are rising at a rate that is dramatically disproportionate to the rest of the healthcare dollar, these MCOs are struggling to come up with ways to help reduce the increase. The ability for MCOs to provide physicians with tools that help them to adhere to plan-specific formularies and assist them in modifying their prescribing behavior in order to become more formulary-compliant is critical to the MCOs. Formulary compliance is critical to the MCO for two reasons: 1) it assures the most cost-effective drug is used, and 2) the MCOs realize “rebates” from drug manufacturers when these drugs are prescribed. A way for MCOs to efficiently optimize their cost is thus highly desirable in this rising healthcare environment.

A recent Merck-Medco Managed Care report suggested that through a retrospective review of physician prescribing, and through the subsequent education of physicians on those findings, an MCO could reduce their drug spend by 4 to 6%. With the average annual drug spend of a plan member at $506.72 in 1999, increasing at a rate upwards of 15% per year, that reduction can represent a significant amount of savings for an MCO-as much as $3.80 per prescription. See “Managing Pharmacy Benefit Costs-New Insights for a New Century,” Merck-Medco Managed Care, LLC, 2000.

The top ten pharmaceutical manufacturers spent over $500,000,000 in 1998 on physician education and marketing alone. The average sales call is estimated to cost $250 and last for 6.6 minutes. As a whole, drug companies spent $6.2 billion to detail products to physicians. That translates into nearly one drug salesperson and almost $100,000 for every practicing physician in the US. Scott-Levin, 1999. These numbers reflect the pharmaceutical industry's need and desire to communicate with physicians, and their willingness to pay for the opportunity to do so.

One way that pharmaceutical companies communicate with physicians is by providing them with complimentary prescription pads. This type of pad contains, for example, the physician's name, address, phone number, and license number. Included also is at least one pre-printed drug name thereby encouraging the physician to prescribe such drug(s). Such complimentary pads, however, do not consider the patient mix of the physician, i.e., the multitude of MCO formularies that should be complied with by the physician. Some medical organizations have offered preprinted prescription forms to their physicians, unfortunately these forms are not personalized to the prescriber and there is no approval or change mechanism associated with the form. These forms are manually produced and do not allow for electronic configuration and communication specific to drugs and prescriber preferences. Because it is not a dynamic process, these forms become obsolete and hence useless without constant attention. Some insurers have attempted to create preprinted prescription forms for prescribers and unfortunately the same shortcomings occur. More importantly, their goal is to drive physicians to prescribe drugs form their formulary, which does not take into consideration all of the formularies a prescriber must manage across a prescriber's patient panel. Because these efforts are singular in nature and do not offer a solution for all patients seen, they are not embraced. Any solution offered to prescribers must be neutral in its position regarding formularies so that its goals are aligned with the group and the physicians. No mechanism has been designed to accomplish this goal to date.

From the discussion above, it should be apparent that there is a need to develop a system or method to assist physicians to prescribe the proper drug with respect to the physicians' payer mix or at least with respect to the preferred formulary(ies) defined by the medical group representing physicians, develop a solution considering the prescribing habits and time constraints of physicians, reduce prescription errors, alert physicians to changes as they occur, as well as address the shortcomings discussed above. The present invention fulfills this need.

### SUMMARY OF THE INVENTION

The present invention provides improved medical prescription services in which a formulary for a physician is placed in a data store and a personalized, physician-specific prescription pad is generated using the stored formulary. In accordance with the invention, a method and apparatus are provided for generating the personalized prescription pads, thereby enabling physicians to comply with formularies, for example, set by their medical group (MG) or indirectly by their insurance group (IG). In one embodiment, the prescription pads are created taking into account several factors, such as the formulary established by the physician's MG or indirectly by the insurance groups of patients seen by the physician (or based on the physician's patient panel) or by the MG in general, the physician's practice area, the efficacy of drugs, rebates from pharmaceutical companies, the drugs most likely to be approved by the insurance groups of the physician's or MG's patient base or panel, prescribing habit of the physician, drugs most frequently prescribed, and the like. From such factors a physician-specific formulary or list of drugs is determined, from which the system creates the physician-specific prescription pads. The prescription pads are typically contained in a prescription services system that optionally includes other features such as a web site portal enabling users of the prescription services system to enter and view information, a service that alerts the appropriate user that previously generated prescription pads should be updated and alerts the physician regarding information about drugs listed in their prescription pads, a database repository as well as a system that merges, collects, and stores information, and an analyzer that performs prescription service analyses and generates reports accordingly.

### BRIEF DESCRIPTION OF THE FIGURES

FIG. 1 is a diagram of an embodiment of a prescription services system constructed in accordance with the present invention.

FIG. 2 is a diagram of an embodiment of the features within the “ScriptIQ” system illustrated in FIG. 1.

FIG. 3 is an exemplary prescription pad provided in accordance with the present invention.

FIG. 4 is a diagram of an embodiment of the operations to generate a personalized prescription pad, called an eScriptPad prescription pad, for a particular physician within the ScriptIQ system, in accordance with the present invention.

FIG. 5 is an exemplary medical group formulary selection guide containing information about formularies of various insurance groups or managed care organizations.

FIG. 6 is a diagram of exemplary database tables used to implement the ScriptIQ system constructed in accordance with the present invention.

FIG. 7 is an exemplary representation of a web page to enter physician information in the Prescriber Portal constructed in accordance with the present invention.

FIG. 8 is an exemplary representation of a web page enabling a user to create an eScriptPad prescription pad in the Prescriber Portal in accordance with the present invention.

FIG. 9 is an exemplary representation of a web page enabling a user to view an eScriptPad prescription pad in the Prescriber Portal in accordance with the present invention.

FIGS. 10 and 11 are exemplary representations of web pages enabling a user to order eScriptPad prescription pads in the Prescriber Portal in accordance with the present invention.

FIG. 12 is an exemplary representation of an alert communication sent to a user.

FIG. 13 is a diagram of another embodiment of the ScriptIQ system constructed in accordance with the present invention wherein additional users are providing information.

FIG. 14 is a diagram showing the conceptual architecture of the ScriptIQ system in accordance with the present invention.

FIG. 15 is a diagram of an embodiment of a business process flow of the ScriptIQ system in accordance with the present invention.

FIG. 16 is a diagram of an embodiment of the operations wherein eScriptPad prescription pads are generated in accordance with the present invention.

FIG. 17 is an exemplary representation of an alert communication sent to a user based on information received from a pharmaceutical company.

FIG. 18 is a diagram of an embodiment of the operations within the ScriptIQ system when an alert-triggering communication is received in accordance with the present invention.

FIG. 19 is a block diagram representation of one of the computers in the systems illustrated in FIGS. 1 and 13.

### DETAILED DESCRIPTION

The following detailed description illustrates the invention by way of example, not by way of limitation of the principles of the invention. This description will clearly enable one skilled in the art to make and use the invention, and describes several embodiments, adaptations, variations, alternatives and uses of the invention, including what we presently believe is the best mode of carrying out the invention.

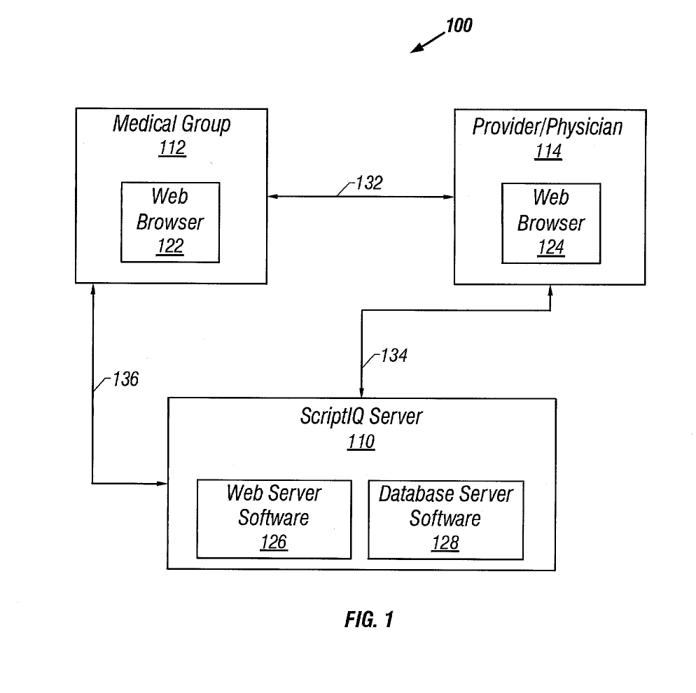

In accordance with the invention, medical prescription services are provided in which a formulary for a physician is placed in a data store and a personalized, physician-specific prescription pad is generated using the stored formulary. In accordance with the invention, a provider of computer applications and physician services, which will be referred to herein as “ScriptlQ”, leverages the power of the Internet to bring physicians a cost-effective technological solution, presented in a very familiar user interface, i.e., the prescription pad. (Physicians, prescribers, doctors, and providers are herein interchangeably use. They refer to any entity that prescribes medications, treatments, drugs, and the like.) FIG. 1 is a diagram of the ScriptIQ system 100 constructed in accordance with the present invention. In this embodiment, the ScriptIQ system has a number of users who subscribe to or are authorized to use the system. Subscribers and users are herein used interchangeably to refer to persons or groups who pay a subscription fee to receive prescription services in accordance with the present invention through the ScriptIQ system. In the FIG. 1 diagram, there are two users, that is, a medical group 112 and a provider or physician 114. Providers typically belong to a medical group 112. A medical group may comprise two or more physicians operating under a common charter or agreement. The medical group 112 and the provider 114 use a computer to communicate with the ScriptIQ server 110. In this embodiment, the ScriptIQ server 110 receives one or more formularies from a medical group (or from other entities), provides facilities to define or generate personalized prescription pads, which herein are called “eScriptPad” prescription pads, for each provider, generates prescription exception analysis report, generates alert-triggering communication, and the like.

As shown, the system 100 includes a ScriptIQ server 110, which typically supports a web server software 126 and database server software 128. The ScriptIQ server 110 may be deployed in one or more computers and the software may run on one of the server computers or may be distributed across multiple computers. Thus, the web server software 126 and database server software 128 may be contained in one computer or may be distributed over multiple computers. Examples of web server software include MICROSOFT® “Internet Information Server” and “Apache” web server software. Examples of database server software include MICROSOFT® “SQL SERVER” and database server software from ORACLE®. In one embodiment of the invention, the ScriptIQ server 110 uses the Windows 2000 Server operating system, MICROSOFT® SQL SERVER 2000 database software, MICROSOFT® Internet Information Server (IIS), MICROSOFT® Office XP, MICROSOFT® Exchange 2000 email software, ADOBE® Acrobat Distiller version 5, and MICROSOFT® NET Framework.

The medical group (MG) user on a computer 112, which also has web browser software 122, communicates with the ScriptIQ server 110 via a data network 136 such as the Internet, a local area network, a wide area network, wireless data network, and the like. Examples of web browser software include “Internet Explorer” from MICROSOFT® Corporation, NETSCAPE® Navigator, and “Opera” by Opera Software AS.

The physician user on a computer 114, which also has a web browser software 124, communicates with the ScriptIQ server 110 via a data network 134. The physician 114 and the medical group 112 may also communicate with each other via a data network 132. The data networks 132, 134, and 136 shown may all be the same network or interconnected networks, such as the Internet.

In one aspect of the present invention, a method and apparatus are provided in which information concerning the actual medical prescriptions written by a particular physician is received, along with information concerning MCO formularies including prescription payment plans, and medication suppliers (e.g., pharmaceutical companies). The collected information is used to create a prescription list of suggested medications, according to the medications most written by the physician, that are most likely to meet with approval for payment by the prescription plans. The physician-specific prescription list is thus generated for use by the particular physician. In this way, a physician may be provided with a personalized prescription pad that includes the physician's most frequently requested medications indicated on the pad for quick selection, with the confidence of knowing that the preprinted selections have been screened for likelihood of approval across multiple payers.

In another aspect of the invention, the physician (user) may utilize an interactive computer network site to uniquely fashion the arrangement of information on the physician's prescription pad, so that the prescription pad that is actually printed will incorporate the particular desires or selected configurations of that physician. For example, the medical group or physician may favor generic over brands of medications, or choose to select the lowest cost brand. The physician may prefer to have drugs listed alphabetically or by drug class. In addition, the medical group or physician may want to be informed about special offers or arrangements related to particular medications, and the information about such special offers or arrangements may affect the physician's choice to opt in or out of certain alert functions. The information from the physician and the information concerning payment may be collected (or received) and provided for review by the physician at the network site.

In another aspect of the invention, the physician may be contacted by network communications to provide personalized alert services. The alert communications or contacts may be made in response to special offers or arrangements that would be of interest to the physician, or may be made in response to information received from product suppliers. For example, dosage or patient side effect information from suppliers may be received at the network site and passed along to the physician, or that a drug has been recalled or that education information is available for review. Changes that relate to the prescriber's personalized drug list are key to the invention. Another example could be a change in formulary, which has resulted in a change in the prescriber list and hence will result in a change on the personalized prescription pad. The communication may involve, for example, a network e-mail message, an Internet Web site posting, a telephone call, or an automated pager message.

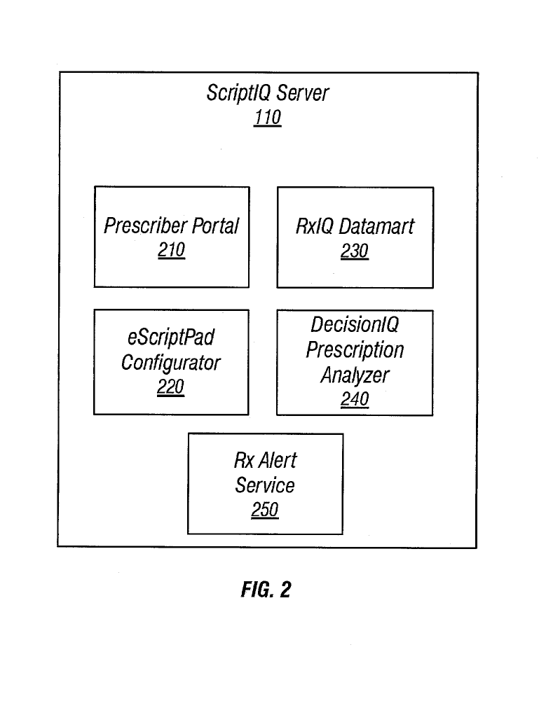

Referring to FIG. 2, in one embodiment, the ScriptIQ server 110 contains the following components or features: the “RxIQ Datamart” 230, the “Prescriber Portal” 210, the “eScriptPad Configurator” 220, the “DecisionIQ Prescription Analyzer” 240, and the “Rx Alert Service” 250.

The “RxIQ Datamart” 230 provides the blending, compilation, and processing of disparate databases, including databases concerning prescriber (physician) history, payer (e.g., insurance group) history, and relevant formularies. Collectively these databases are called the “RxIQ Datamart.” Payers, in this embodiment, include managed care organizations (MCOs), herein interchangeably referred to as insurance groups. From this RxIQ Datamart, a matrix formulary can be generated that spans across all payers (insurance groups) within the prescriber's panel (patients) (also known as the “payer mix”). This matrix formulary may be used for benchmark analysis, drug spend analysis, generation of preferred drug lists and preprinted personalized prescription pads, and as a basis for tailored education and communication relative to a preferred list of medications specific to a prescriber's (physician's) prescribing habits.

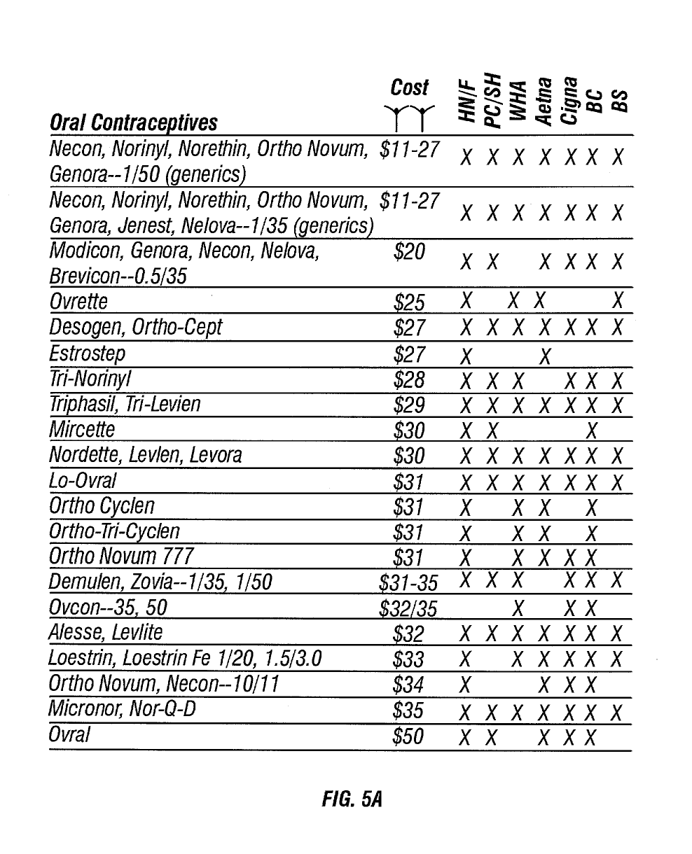

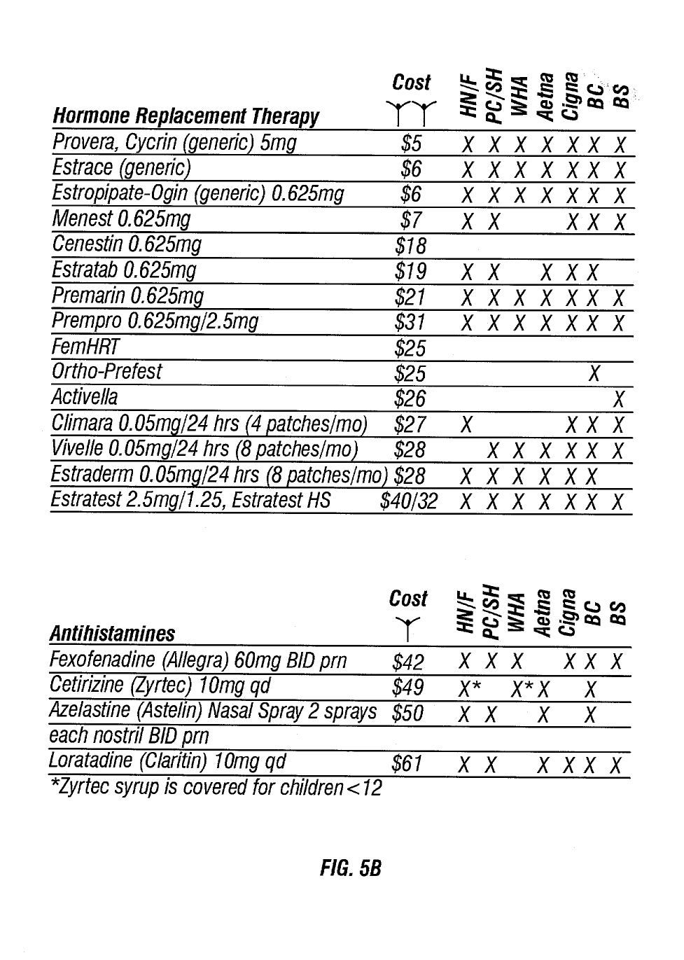

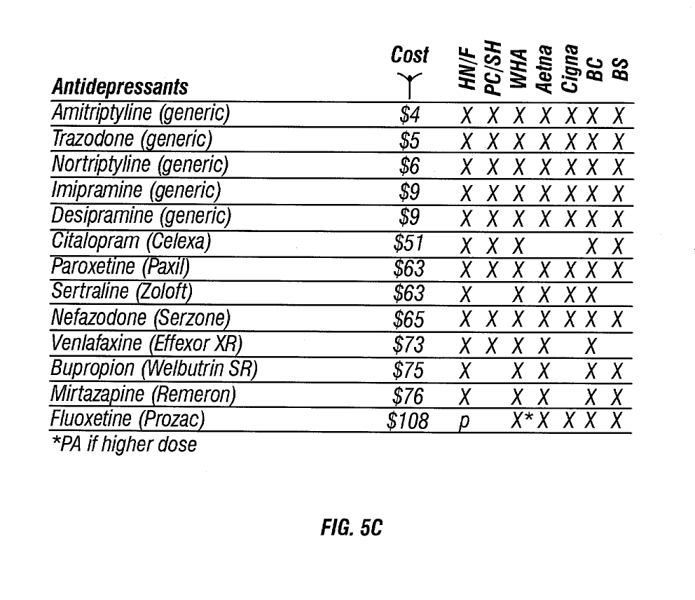

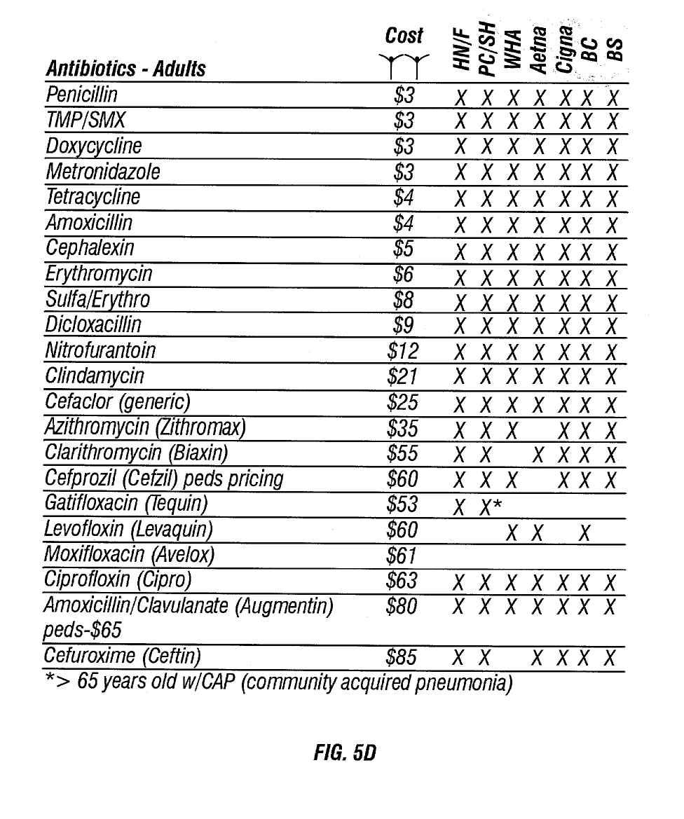

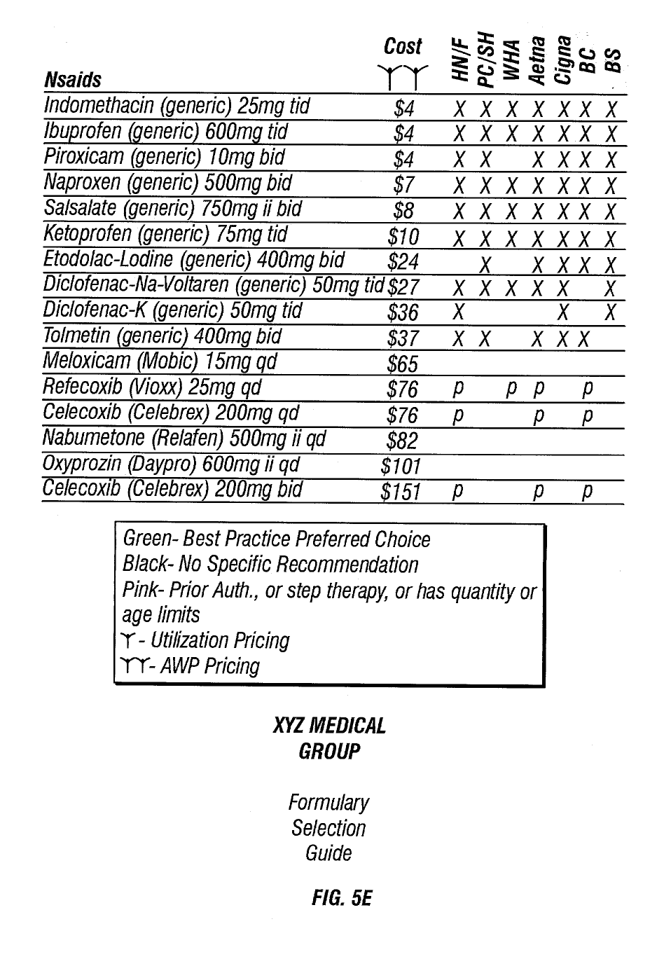

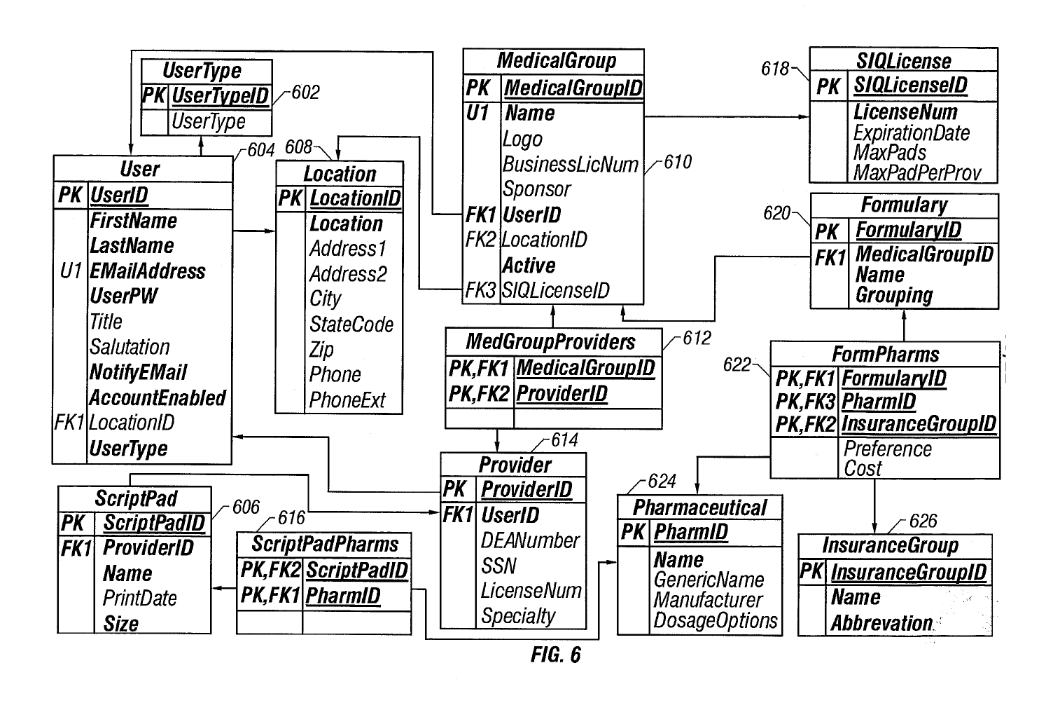

The RxIQ Datamart 230 may be implemented using database management system software. It may also be implemented using other development tools, such as high-level programming languages, such as C++, Visual Basic, Java, etc. FIG. 5 may be a basis to create a matrix formulary across several insurance groups. FIG. 6 shows exemplary database tables within the RxIQ Datamart 230.

The “Prescriber Portal” 210 represents a platform/network for interactive communication amongst all users or stakeholders in the ScriptIQ system 100 who are involved or interested in the prescribing process of the physician. These users have a near real-time opportunity to communicate with the prescribing physician through this interactive network. Depending on embodiment, these users include payers (e.g., insurance groups), drug companies, pharmacies, medical groups, physicians, and others.

The Prescriber Portal 210 in one-embodiment is a web-based communication and service site, or network node. One of its features is to enable certain users within the system to create eScriptPad prescription pads for physicians. Such users may include the physicians (prescribers) and administrative leadership (e.g., medical group administrator (MGA)) in the medical group model. Furthermore, it enables such users, using the Prescriber Portal 210, which may also interface with the eScriptPad Configurator 220, to design a customized prescription pad that is based, for example, on: 1) the normal prescribing practices of physicians in an MG, 2) the MG's existing payer mix across the MG's actual patient panel, and 3) the approved drugs by the appropriate insurance group as defined by their formularies.

Although an eScriptPad prescription pad is a practical result of the Script IQ solution described herein, it is anticipated that the Script IQ Prescriber Portal 210 may become the physician's trusted source for drug information, and communication and services. The Prescriber Portal thus saves the physician time and money by communicating information and offering services that are specifically tailored to the physician's individual prescribing habits. This results in welcomed time savings as now, for the first time, physicians receive timely information that is tailored and relevant to their prescribing habits. It is anticipated that all of this will encourage the adoption of the Script IQ solution.

The Prescriber Portal 210 may be implemented by various development tools. It may be implemented using web server software (e.g., MICROSOFT® IIS) and scripting languages, such as Active Server Pages, ALLAIRE® ColdFusion, PERL, NET Framework development tools, and the like. It may also be developed by high-level programming language development tools, e.g., Java, C++, Visual Basic, etc.

In another embodiment of the invention, the Prescriber Portal 210 may be used for co-branding purposes. For example, the Prescriber Portal may be used to host the MG's web site to inform members of the MG, e.g., physicians, staff, etc., of changes that may affect how the MG and its physicians are doing business. The MG web site may provide the latest information about pharmaceuticals frequently prescribed by its providers, changes in insurance group policies, and other information, which the MG may deem pertinent to be posted in its web site, via the Prescriber Portal 210.

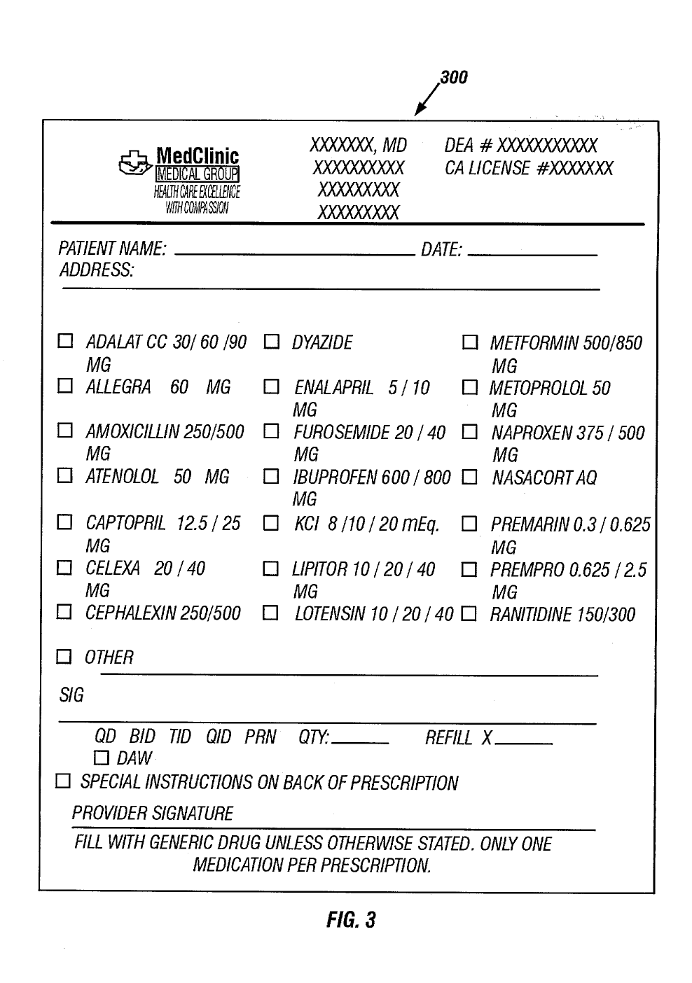

The “eScriptPad Configurator” 220 provides a physician-specific preprinted, (optionally) fraud-proof, check-off prescription pad that represents formulary-compliant medications, specific to the physician's payer mix (patient panel) and practice. The primary output of the eScriptPad Configurator 220 are the custom pre-printed prescription pads that are referred to herein as eScriptPad prescription pads. An eScriptPad prescription pad, however, is not a radical change from the current prescribing practice of physicians because the prescribing means or device is still the traditional paper and pen, and therefore takes just seconds to do. The tailoring of the matrix formulary (or list of medications) specific to the physician may be accomplished using the RxIQ Datamart 230, other electronic mechanisms, or manually through the blending of similar data as collected and aggregated by a specific entity (for instance, payers or medical groups), so long as the matrix formulary makes its way into the ScriptIQ database, described further below. See FIG. 3 for an example of a sheet 300 from an eScriptPad prescription pad.

In identifying the list of medications, pharmaceuticals, or drugs to be included in the eScriptPad prescription pads of a physician, various factors may be considered, including the medications, which address the most common conditions experienced by the physicians' patients (historically), medications that are covered by the formulary requirements of the plans of the patient panel (i.e., MCO formularies), the lowest-cost, non-generic medication on formulary when redundant medications are covered, selection of a generic alternative, and the most common strength and quantity for each medication prescribed (historically). An MCO formulary thus may include payment information concerning prescription payment plans. Other factors not listed may also be included, for example, those dependent on the physician's prescribing habits, requirements of the medical group, and the like.

In one embodiment, an interface is provided to a user to confirm the list of medications (or formulary) and finalize any printing options for the eScriptPad prescription pad. The eScriptPad Configurator 220 may interface with the Prescriber Portal 210. Configuration options include, but are not limited to, sort order of the listed medications, strength and quantity of the medications, paper stock (e.g., fraud-proof stock), size of the eScriptPad prescription pad, logo settings, medication samples/voucher offers, and the like. Thus, an eScriptPad prescription pad 300 may list medications according to the configuration options selected by the user, and in a format that is specific to the physician's state regulations (as mandated by that state's Board of Pharmacy). The prescription pads 300 may be purchased by a user or for a user in a sponsored model (based upon security authorization) and shipped to the appropriate address.

In one embodiment, the eScriptPad Configurator 220 may also analyze the various formularies contained in the RxIQ Datamart 230, and based on such formularies available determine the list of medications that are most likely to be approved for payment by the MCOs.

The eScriptPad Configurator 220 may be implemented in various ways. In one embodiment, it may be implemented by using various development tools, e.g., a combination of high-level programming language development tools, web server software, scripting language tools, database management system software, and publishing development tools (e.g., ADOBE® Distiller). Those skilled in the art will understand how to implement a user interface to support the configuration tasks described herein for the eScriptPad Configurator 220, in view of this description.

The “DecisionIQ Prescription Analyzer” 240 performs analysis and generates appropriate outputs (e.g., reports) on the data collected within the datamart. Such analyses include prescription exception analysis, most prescribed drugs, physician compliance within medical group's preferred formulary, etc. The DecisionIQ Prescription Analyzer may be implemented in many ways. In one embodiment, it is implemented using high-level programming development tool, report creation tools, publishing development tools, etc.

The “Rx Alert Service” 250 performs alert processing within the ScriptIQ system 100 when certain alert-triggering information or an alert-triggering condition is received or occurs. Alert-triggering information is any information or condition that affects the eScriptPad prescription pads 300 of physicians. In this embodiment, a change to the MG formulary may result to some physician's pads 300 becoming outdated. In one embodiment, the Rx Alert Service 250 sends a communication to the appropriate user(s), e.g., the medical group administrator (MGA), informing such person that some pads 300 within the MG need to be updated. The MGA is thus informed to take appropriate action, such as sending emails to the affected physicians informing them to change their prescription pads 300, to go to the Prescriber Portal 210 to approve a new set of proposed eScriptPad prescription pads, to order new eScriptPad prescription pads for their use, and the like. In another embodiment, changes by the MGA to the MG formulary may automatically result in creation or generation of new eScriptPad prescription pads or the placing of order for new revised eScriptPad prescription pads. In one embodiment, the communication sent to the MGA by the Rx Alert Service lists all the physicians affected by the MG formulary change. In another embodiment, changes in the provider information, e.g., address, license number, and the like may also be considered as alert-triggering conditions. See FIG. 12 for an exemplary representation of an alert communication sent to an MGA.

FIG. 3 shows a sheet from an exemplary eScriptPad prescription pad 300 provided in accordance with the present invention. An eScriptPad prescription pad 300 is a personalized physician-specific prescription pad. The design of such prescription pad 300 may consider the physician's practice, the medical group the physician belongs to, the insurance groups that the physician's patient base may belong to, the efficacy of drugs, the costs of drugs, special offers from pharmaceutical companies, etc. The eScriptPad prescription pad thus provides physicians with a customized, formulary-compliant, pre-printed prescription pad that can be used in the same way as a traditional prescription pad (with pen and paper) and therefore takes just seconds to complete. The eScriptPad prescription pad also resides in a very familiar place-the physician's coat pocket thereby providing powerful information and solution without requiring a wholesale change in the way medicine is practiced. In one embodiment, the eScriptPad prescription pads are printed on fraud-proof paper. This type of paper typically cannot be copied by ordinary means thereby alleviating the fraudulent scenario wherein a physician's prescription pad is illegally copied and used. Companies, such as, Micro Format, Inc., in Wheeling, Ill., provide this fraud-proof type of paper.

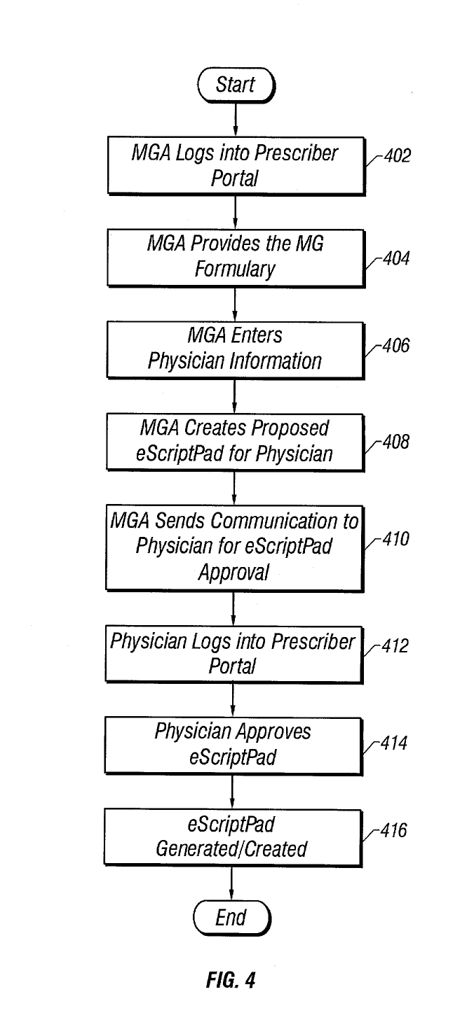

FIG. 4 is a diagram of the sequence of the operations that may be used to create an eScriptPad prescription pad for a particular physician within the ScriptIQ system constructed in accordance with the present invention. In this FIG. 4 embodiment, a medical group administrator (MGA) initially creates a proposed eScriptPad prescription pad for approval by the physicians. This model considers the busy schedules of physicians and therefore does not require the participation of a physician to produce the initial pad configuration. Physicians, however, may also directly create their own eScriptPad prescription pads. Although FIG. 4 shows the intervention of the MGA, depending on the model of implementation, the MGA intervention may be skipped and be directly handled by the physician or by another appropriate user in the system.

In the first operation 402, a medical group administrator (MGA) logs into the Prescriber Portal. The MGA does this, for example, by supplying proper user name and password. In this model, the MGA is typically in-charge of creating formularies, including a preferred formulary, for a specific medical group (MG). See FIG. 5 for an exemplary formulary for XYZ Medical Group.

In the next operation 404, the MGA provides or creates an MG formulary to the ScriptIQ server 110 (FIG. 1). This MG formulary is a list of drugs designed for the providers or physicians of that MG and from which providers typically should prescribe. The MG formulary is typically stored as part of the RxIQ Datamart 230. The MG formulary may be entered interactively via the Prescriber Portal 210 or may be uploaded to the ScriptIQ server 110 via a data communication software such as FTP. In another embodiment, the MGA may send a diskette to the administrator of the ScriptIQ system. The information contained in the diskette is then loaded into the appropriate databases in the RxIQ Datamart. (See FIG. 6 for exemplary tables in the RxIQ Datamart.) Other ways to load the MG formulary into the RxIQ Datamart are known in the art. In one embodiment, a medical group may have more than one formulary.

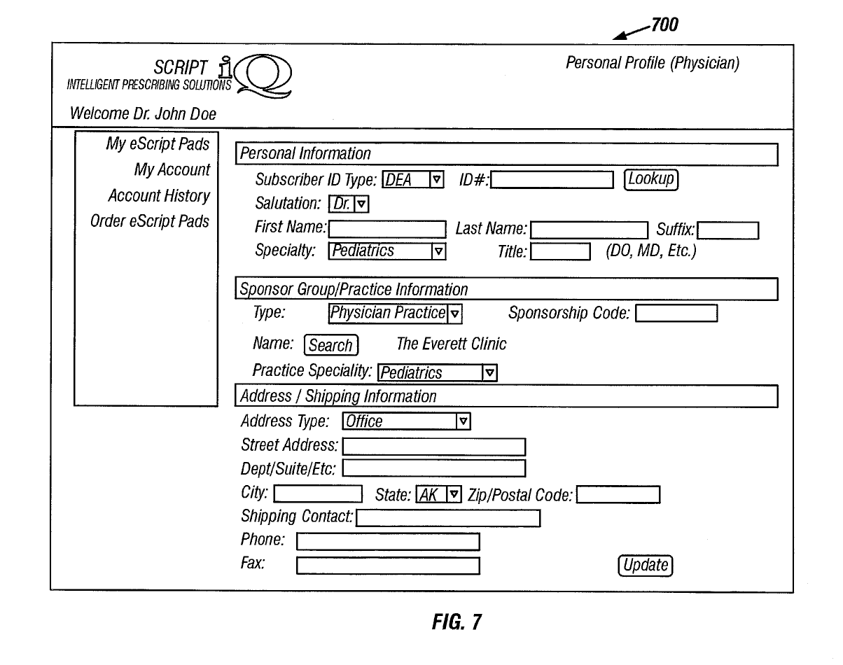

In the next operation 406, the MGA enters or provides the physician information. This may be done by directly entering the information using the Prescriber Portal. FIG. 7, for example, is a representation of what a physician data entry page of the Prescriber Portal may look like. The provider information may also be uploaded, for example, by FTP or bulk copy to the ScriptIQ server 110 and stored in the RxIQ Datamart 230.

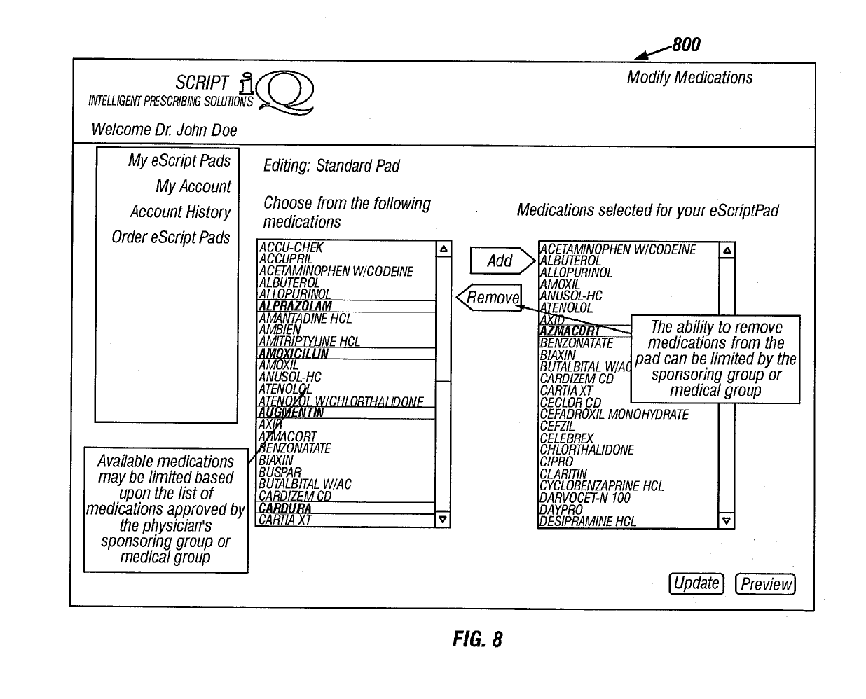

In the next operation 408, the MGA creates a proposed eScriptPad(s) for the physician. In one embodiment, this is accomplished by creating a formulary for that particular physician. Factors such as provider's specialty or department may be taken into consideration. FIG. 8 is an exemplary representation of a web page enabling an MGA to create a formulary for a particular physician. The drugs that are displayed in the list boxes in one embodiment are dependent on the MG preferred formulary. The drugs selected are then stored in the RxIQ Datamart, in particular, for example, in the ScriptPadPharms table 616 in FIG. 6. The RxIQ Datamart, depending on system design and implementation, may be a temporary or permanent data store.

From this physician-specific formulary or list of pharmaceuticals created, a proposed eScriptPad prescription pad is generated. In one embodiment, the eScriptPad Configurator 220 does this by taking the physician-specific formulary and using a software application such as ADOBE® Distiller to create a PDF file (Adobe portable document format) to format this formulary to a prescription pad 300 as shown in FIG. 3. This PDF file may be used as a proof or artwork to print hard copies of eScriptPad prescription pads.

In the next operation 410, the MGA sends a communication, e.g., an email, to the physician using the data network 132 (FIG. 1). This communication informs the provider that a proposed eScriptPad has been created for the provider's review and approval. This communication may also be via regular phone, fax, text-enabled messaging devices, and other mechanisms of communication. Wireless communications may also be used.

In the next operation 412, the physician logs into the Prescriber Portal, e.g., by supplying a user name and password. Once validated by the system, the physician is then presented with the appropriate web page(s). In one embodiment, a hyperlink is embedded in the email sent by the MGA (previous step), thus, a physician only has to click the hyperlink and provide the necessary information to access the appropriate page.

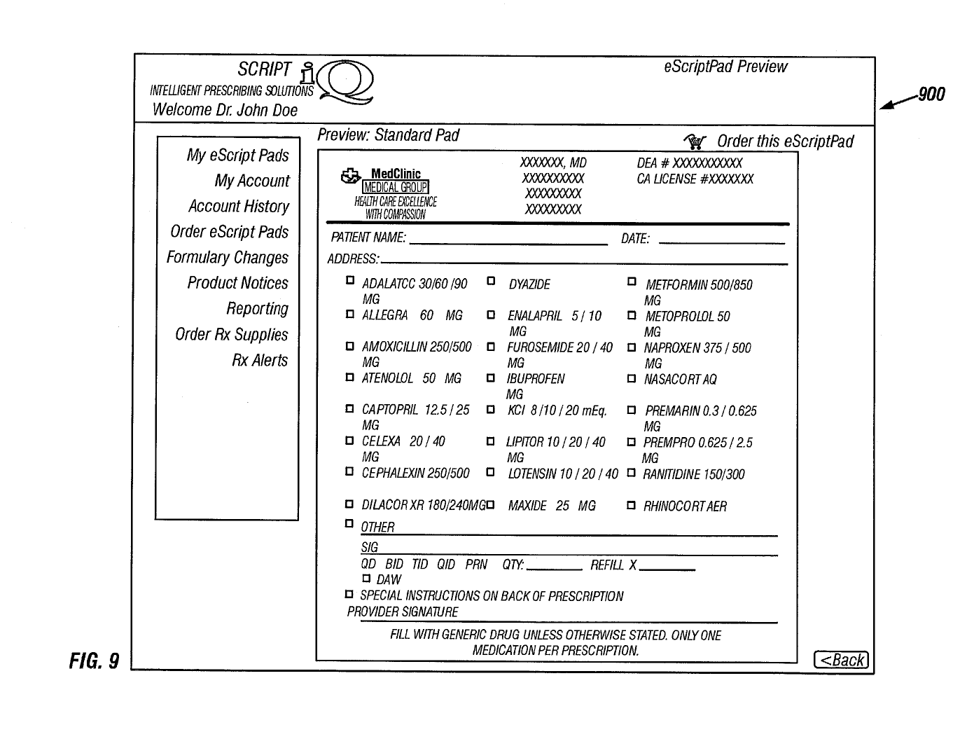

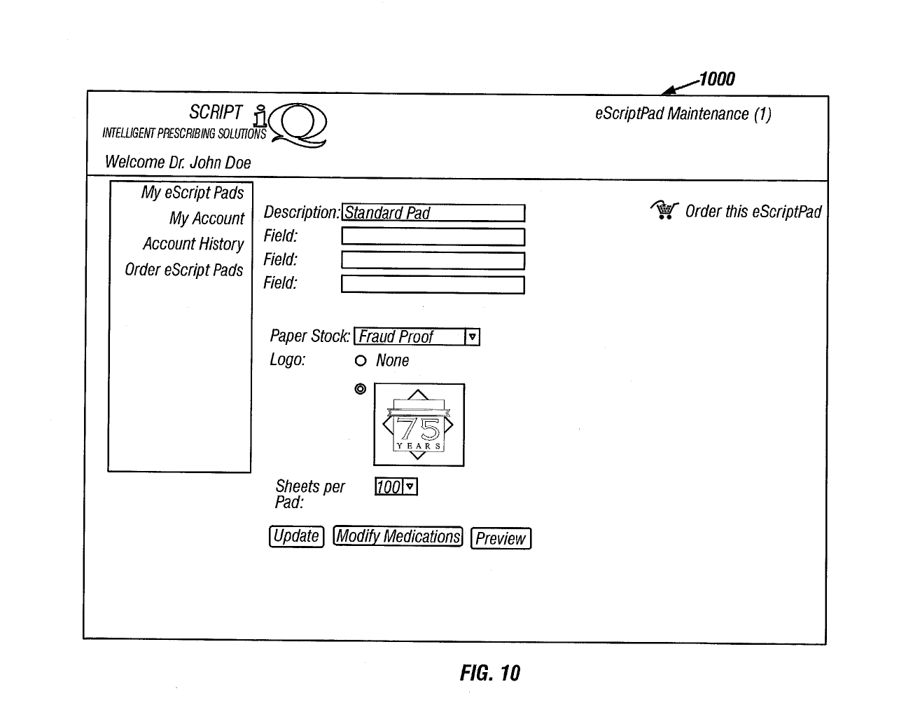

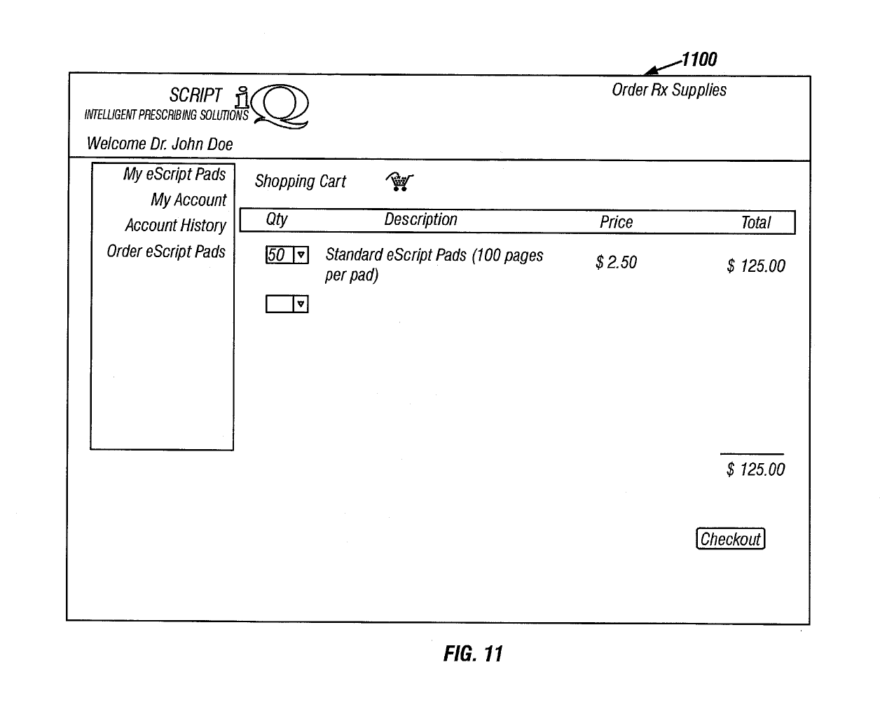

In the next operation 414, the physician approves the proposed eScriptPad prescription pad(s) created by the MGA. This operation may also involved having the physician revise the proposed prescription pads, create new eScriptPad prescription pads, specify configuration options, and the like. FIG. 9, for example, is a representation of a web page enabling a user to view a proposed eScriptPad prescription pad using the tools within the Prescriber Portal. The Prescriber Portal, with the eScriptPad Configurator, also enables a user to print the proposed prescription pad 300, make changes to the proposed prescription pad, create new or additional eScriptPad prescription pads, approve the proposed eScriptPad prescription pad, make changes to the physician-specific formulary, and the like. Such information may be stored in the RxIQ Datamart. Once the physician approves the eScriptPad prescription pad(s), other pages, e.g., set-up page, order page, and the like may also be presented. See FIGS. 10 and 11.

In the next operation 416, one or more eScriptPad prescription pads are generated. In one embodiment, this is accomplished by creating one or more PDF files, which are then stored in a data store. Hard copy output may also be generated. In the preferred embodiment, the PDFs files are sent to a commercial printer for printing. In another embodiment, the authorized user may have a printer capable of printing the eScriptPad prescription pads using the proofs (PDFs) created.

FIG. 5 lists exemplary formularies for the XYZ Medical Group. These formularies may be further restricted to a narrower list of drugs, i.e., the formulary only includes drugs approved by all seven insurance groups.

FIG. 6 is a database diagram of exemplary database tables used to implement the ScriptIQ system 100 shown in FIG. 1 constructed in accordance with the present invention. One of the MG formularies may be contained, for example, in the FormPharms table 622. In one embodiment, only one preferred formulary is stored in the FormPharms table. How such formularies are defined may depend on the policies of the MG, e.g., the policy is to have a formulary specifically tailored to only four insurance groups or to have a formulary with the broadest insurance group coverage (or payer mix) across the patient panel.

Briefly describing the tables in FIG. 6, the MedicalGroup table 610 contains the MG information, such as MG name, address, business license number, the ScriptIQ license information, and the like. The SIQLicense table 618 contains the ScriptIQ license number information, when such license to use the ScriptIQ system 100 expires, how many eScriptPad prescription pads are allowed in this license, and other licensing-related information. The FormPharms table 622 contains the formularies for the MG and the preference information about a specific pharmaceutical product in the formulary. The InsuranceGroup table 626 contains information about insurance groups, MCO's, insurance carriers, and the like. The Pharmaceutical table 624 contains drug or pharmaceutical information including generic name, manufacturer, and dosage options. The Formulary table 620 links the MedicalGroup table 610 and the FormPharms table 622. The Provider table 614 contains provider or physician information, including their SSN, license number, DEA number, specialty, practice area, and the like. The MedGroupProviders table 612 identifies the MG to which a physician belongs. The Location table 608 contains address information. The ScriptPad table 606 contains the various eScriptPad prescription pads created for various physicians. The ScriptPadPharms table 616 identifies the drugs listed in a provider's eScriptPad. The User table 604 identifies the users within the ScriptIQ system 100, including the user's email address. The UserType table 602 identifies the user type, for example, provider, MG, insurance group (IG), etc.

FIG. 7 is an exemplary representation of a web page 700 that may be used to enter physician information in the Prescriber Portal constructed in accordance with the present invention. For example, the FIG. 7 screen may be used to collect subscriber personal information, sponsor group information, and address information.

FIG. 8 is an exemplary representation of a web page 800 enabling a user to create an eScriptPad prescription pad in the Prescriber Portal in accordance with the present invention. The screen interface may be used to add and remove medications (pharmaceuticals) from a pad configuration.

FIG. 9 is an exemplary representation of a web page 900 enabling a user to view an eScriptPad in the Prescriber Portal in accordance with the present invention.

FIG. 10 is an exemplary web page 1000 enabling any allowed user to further define an eScriptPad prescription pad, e.g., define what paper type to use, whether a specific format of prescription pad is going to be used, and other-paper related or printing-information.

FIG. 11 is an exemplary web page 1100 enabling a user to order the desired quantity of eScriptPad prescription pads. This may be accessed by authorized users.

FIG. 12 is an exemplary representation of an alert communication sent to a medical group administrator.

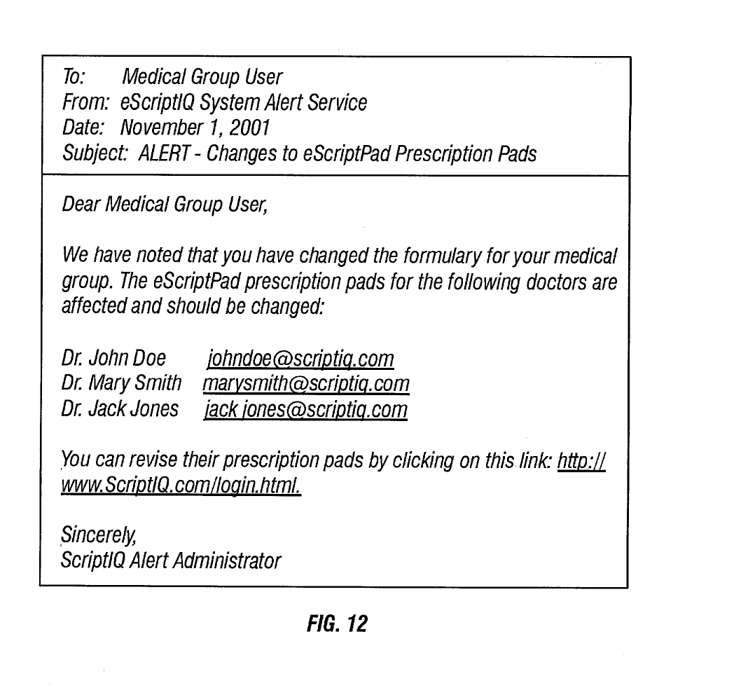

FIG. 13 shows another embodiment of the ScriptIQ system (first shown in FIG. 1) with additional users or subscribers, particularly a pharmaceutical company 1316 and an insurance group (IG) 1318. In FIG. 13, like reference numerals with FIG. 1 refer to like elements or structures. The discussion above regarding the medical group 112 and provider 114 may also equally apply to this ScriptIQ system 100. The numbering scheme is the same with FIG. 1, except for the additional diagrams identified with a numbering scheme starting in the 1300 series. Furthermore, although the present figure shows both the pharmaceutical company 1316 and insurance group 1318, it is understood that the system may still function without any of these users as shown in FIG. 1. Furthermore, the ScriptIQ system will also function if either the pharmaceutical company 1316 or the insurance group 1318 is not part of the ScriptIQ system. Reporting capabilities and alert triggering information, however, may be different depending on the users within the system 100.

The ScriptIQ system in this embodiment provides a two-way communication opportunity that pharmaceutical companies may use for e.g., as a channel for eDetailing (electronic communication) and other educational opportunities, sample order and replenishment, sample voucher order and replenishment, product-specific alert functions for recalls and new therapies, access to physician-specific web site pages, clinical trial recruitment, and the like. This means that users may access information provided by pharmaceutical systems to the ScriptIQ system, e.g., via the Prescriber Portal. In addition, this may also be used by the pharmaceutical companies to directly communicate with physicians whose prescribing habits are directly affected, for example, because of drug updates such as recall notices, notifications of new side effects, notifications of contraindications, and the like.

The ScriptIQ system (FIG. 1 and FIG. 13) may also be used by insurance groups to inform physicians and medical groups of changes in their formularies or covered medications. Information such as payment information, limitations, restrictions, and the like may be included in the formularies of the insurance groups. With the above information, the prescribing habits of physicians may be changed to comply with such formulary rules.

The Script IQ Prescriber Portal and eScriptPad Configurator thus provide MCOs (including PBMs) and their affiliated physicians with: (1) An adaptable tool for physicians and medical groups that aids formulary compliance; (2) Clean, legible and possibly fraud-proof prescriptions, which reduces administrative burden for all users, and reduce hospitalization as a result of errors; and (3) Near real-time communication to physicians for formulary changes, drug recall alerts, education, for example. All of the aforementioned is personalized to the prescriber based on a personalized listing of drugs or formulary, which is also represented in an eScriptPad prescription pad.

In this embodiment, a pharmaceutical company using a computer 1316 containing a web browser 1326 communicates with the ScriptIQ server 110 via a data network 1336. Similarly, an insurance group on a computer 1318, containing a web browser software 1328, communicates with the ScriptIQ server 110 via a data network 1334.

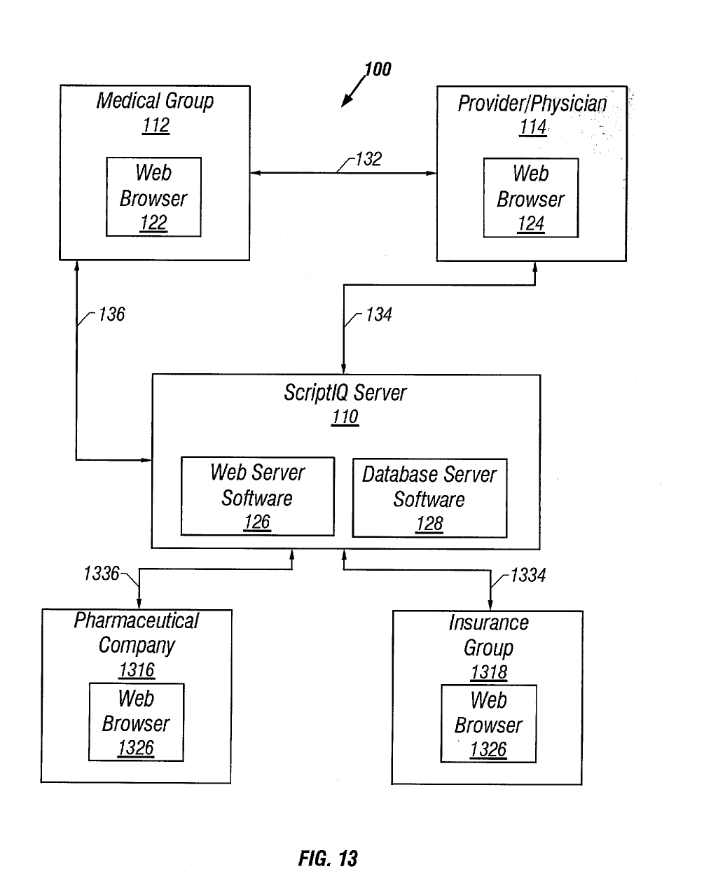

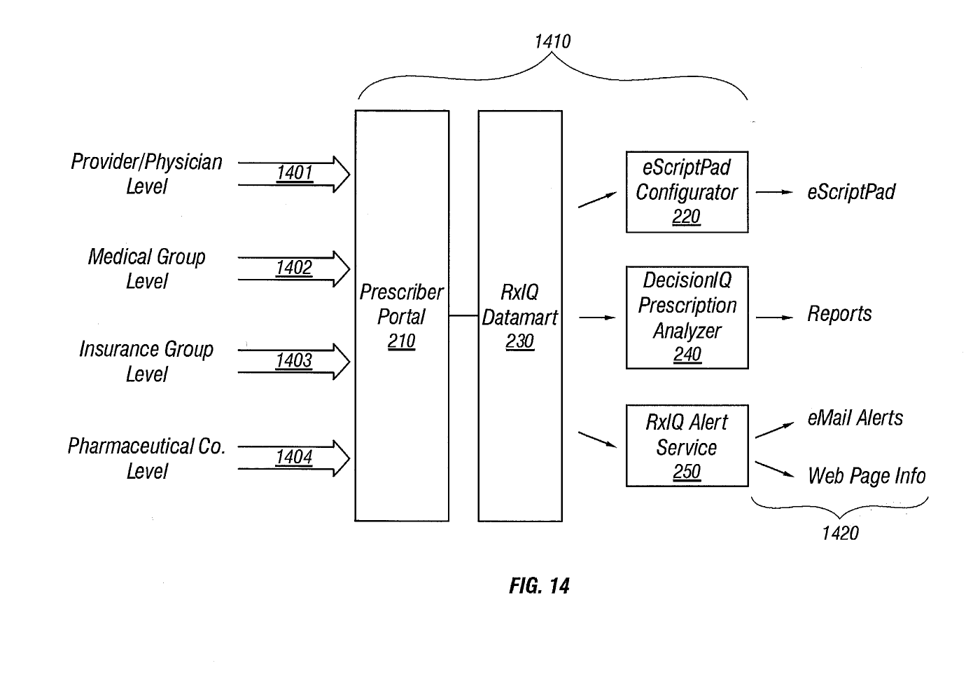

FIG. 14 is a representation of the ScriptIQ conceptual architecture. As shown in this figure, information is collected from prescribing physicians, medical groups, insurance groups (payers or MCOs), and pharmaceutical companies or medication suppliers. Each user provides information to the ScriptIQ system 1410 to generate several outputs 1420 as shown. On the physician/provider level, information about actual drugs prescribed and filled 1401 and information about the eScriptPad prescription pads of physicians are provided to the ScriptIQ system 100. Although the input arrows 1401, 1402, 1403, 1404 are shown to interface with a Prescriber Portal 210, depending on system design and implementation, information may be directly provided to the RxIQ Datamart 230 without interfacing with the Prescriber Portal 210. In the Medical Group level, MG-related information 1402, e.g., MG formularies, alert-triggering MG information, and the like, is provided to the ScriptIQ system 100. In the Insurance Group (IG) level, IG-related information 1403, e.g., IG formularies, alert-triggering IG information, and the like, is provided to the ScriptIQ system 100. In the Pharmaceutical Company level, pharmaceutical company-related information 1404, e.g., drug information, sample voucher information, drug recalls, drug-related information, and the like, is provided to the ScriptIQ system 100. Depending on the information in the ScriptIQ system 100, eScriptPad prescription pads, reports, email alerts (or any other alert communication), web page information, and the like 1420 are generated by the ScriptIQ system 100 using the various features 1410 of the present invention.

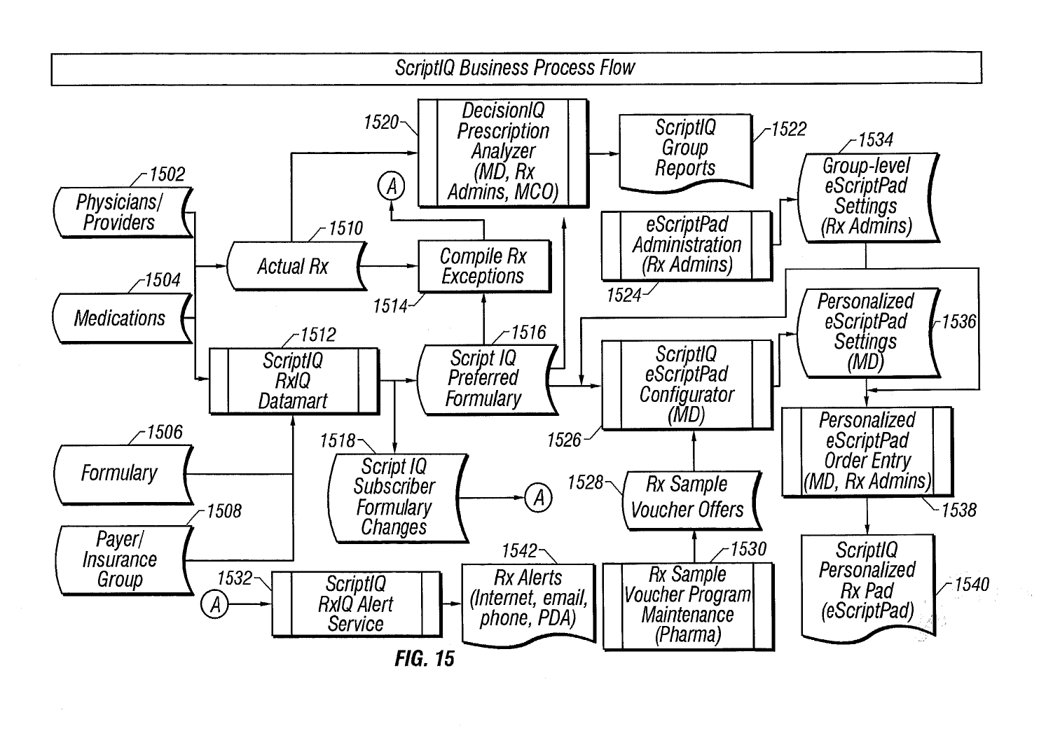

FIG. 15 is a more detailed business process flow diagram that illustrates the flow of information in the ScriptIQ system 100. Information is collected from prescribing physicians, medical groups, insurance groups, and pharmaceutical companies (similar to FIG. 14). Information about providers or physicians 1502 (also MD in this figure) and actual medications prescribed and filled 1504 are collected to obtain information regarding actual prescriptions 1510 issued by such physicians.

The ScriptIQ system of the present invention thus may also receive information regarding what drugs or medications are actually being prescribed and what ought to be prescribed. The first category is data that describe the medications prescribed to patients, as a result of the visit, and are subsequently purchased. Information on what ought to be prescribed is located both in the formulary plans put in place typically by insurance groups and the cost comparisons between like medications. Naturally, payers or IGs prefer to pay for the least expensive medication that successfully treats the patient's condition. Given information on the patient's condition, their insurance plan, the specific coverage the patient has enrolled in and the cost of a certain medication, there is an optimal medication the physician should prescribe. In one embodiment, this is captured in the MG formulary and accordingly in the eScriptPad prescription pads for physicians.

Information about actual prescriptions filled 1510 are usually obtained from pharmacies and are gathered by third-parties such as by NDCHealth (offices in several locations including Phoenix, Ariz.) and IMS Health in Fairfield, Conn. Prescription Exceptions (e.g., reports) 1514 may also be generated by comparing actual prescriptions prescribed and filled versus the formulary set by the Medical Group or by the Insurance Group. This may be accomplished by using the DecisionIQ Prescription Analyzer 1520 of the system. Reports relevant to physicians, MGAs, MCOs, and the like may accordingly be generated 1522. An example of such report is one listing drugs prescribed outside of the MG preferred formulary sorted by physician.

Formularies from Medical Groups and Insurance groups 1506, 1508 may also be provided, collected, or entered into the ScriptIQ system. The information from the various block 1502, 1504, 1506, and 1508 is merged, processed, and stored, using the RxIQ Datamart, 1512 to create a ScriptIQ preferred formulary or desired prescription database 1516. This preferred formulary 1516 may include formularies by Medical Group, by Physician, and by Insurance Group.

The RxIQ Datamart 1512 contains information merged, combined, or processed together and is available at a network data location where it can be accessed by the physicians, medical groups, insurance groups, and pharmaceutical companies via the ScriptIQ tools, such as DecisionIQ Prescription Analyzer 1520, the Prescriber Portal, eScriptPad Configurator, and the like. In one embodiment, the information collected is stored as a database resource.

A formulary for a medical group may also be provided into the ScriptIQ system, as indicated at the block 1534. The group-level eScriptPad settings may be in a form of formulary or list of drugs defined by the MGA of the MG. This group level eScriptPad settings are in turn stored in a data store for later retrieval or updates, if necessary.

In terms of formulary, a physician typically should abide by the preferred formulary(ies) of the MG. In one embodiment, the MGA may select an option that will only allow for changes to be made that are part of the MG preferred formulary. The formularies provided by various IGs may also be considered by the MG in defining its preferred MG formulary. Automatic creation of the preferred MG formulary may also be done if the formularies of insurance groups are collected or received within the system. In one embodiment, a preferred formulary for a MG is created by including only drugs approved by all IGs of the patient base of the medical group, including only drugs with the lowest cost, and the like. The automatically-generated MG formulary may also be edited by the MG. The rules to define the preferred MG formulary may depend on the MG administrative policies, which may include the biggest IG carrier across its patient panel, efficacy of drugs, cost, pharmaceutical company's rebates, and the like.

A ScriptIQ Preferred Formulary (or “Desired Rx” database) is produced at block 1516. In one embodiment, the formulary comprises a list of suggested medications that are most favorable to physicians, in terms of greatest likelihood to be approved by a payer or insurance group.

From time to time, information may become available that is likely of importance to the users within the system. Such information may originate from, for example, pharmaceutical companies or medical suppliers to inform physicians of special offerings 1528, changes in drug recommendations or dosages, formulary changes, and the like. The information may further comprise payment restrictions or changes from insurance plans or may comprise changes to formularies from multiple suppliers. Such information may be retrieved from the database (or RxIQ Datamart) for analysis and incorporation into the eScriptPad prescription pads 1536. This information may also be delivered to individual physicians or appropriate users by an Rx Alert Service 1532. The Rx Alert Service may communicate with the appropriate users by a variety of methods 1542, including e-mail, telephone, pager, and viewable pages at a network location such as a web site. (85% of physicians utilize the Internet today-primarily for e-mail and research. See Healtheon/WebMD (Survey of 10,000 Physicians, October 1999-as presented at the AAHP 2000 Conference) June 2000.) This is important, as notifications to return to the Prescriber Portal for important information (drug alerts, formulary changes, re-order notices, etc.) may also be delivered through this medium. In one embodiment, the Rx Alert service provides information through a graphical user interface such as a Web browser, where a physician can readily view the information.

From pharmaceutical companies, sample voucher programs (drug sample programs), rebates, and the like may be fed into the system as shown by the blocks 1528 and 1530. This set of information may also be considered by the eScriptPad Configurator 1526, when creating physician-specific eScriptPad prescription pads.

A network interface, e.g., such as the Prescriber Portal, enables the individual physician to submit an order for a preprinted prescription pad, to view the database, and to preview and edit the arrangement of the preprinted prescription pad. This may also comprise a pad configurator or personalized pad builder called eScriptPad Configurator 1526.

Personalized eScriptPad settings 1536 are physician-specific formularies used to create physician-specific eScriptPad prescription pads 1540.

In one embodiment, the eScriptPad Configurator 1526 is preferably a computer application that provides a graphical user interface, such as through a web browser, to display information from the database or from RxIQ Datamart. Using the eScriptPad Configurator 1526, personalized eScriptPad prescription pad settings by physician 1536 may be stored. In one embodiment, these personalized settings are stored as a list of drugs or formulary. In one embodiment, eScriptPad order entry interface 1538 may also be available as shown for example in FIGS. 10 and 11.

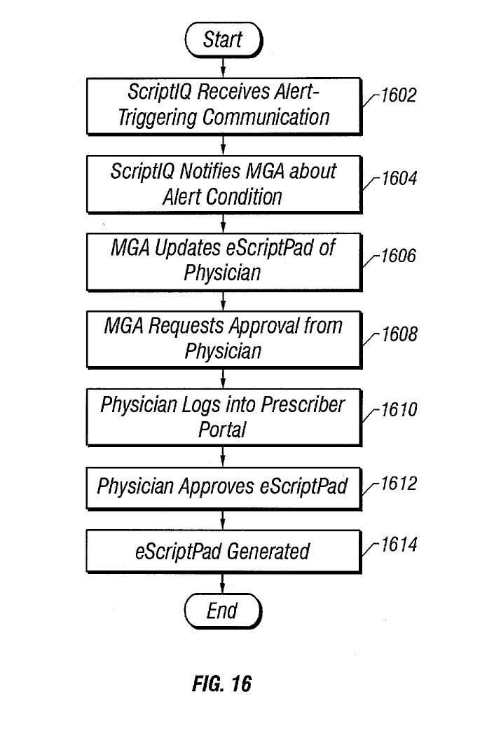

FIG. 16 is a basic flow diagram illustrating how alert communications are sent using the Rx Alert Service of the ScriptIQ system of the present invention. In the first operation 1602, the ScriptIQ system 100 received an alert-triggering communication or information. This alert-triggering communication may be received from a user entering information through the Prescriber Portal 210. In another embodiment, this alert-triggering communication may be received by the administration of the ScriptIQ server 100, via email, diskette, phone, and the like.

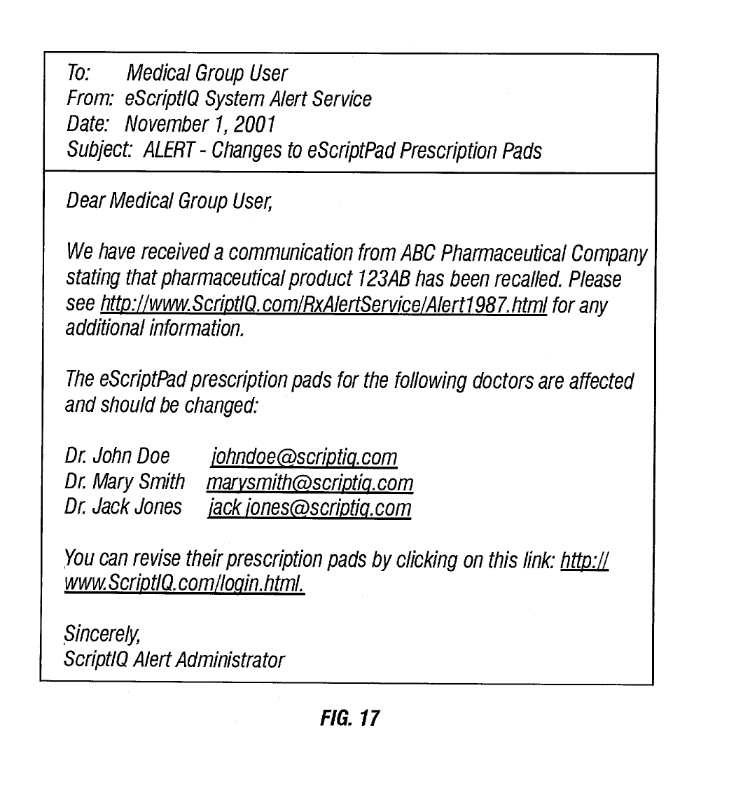

An alert-triggering communication or information is any communication received by any mechanisms, which affects the eScriptPad prescription pads of physicians. Such alert-triggering information may also include other relevant information, such as that the preferred formulary of the medical group or the formulary of an insurance group has changed, a drug in an eScriptPad prescription pad is no longer available as an approved medication, a drug has been recalled, and the like. By focusing the alert-triggering communication on the physician's formulary(ies), i.e., the list of drugs chosen by the physician to be placed on the eScriptPad prescription pads, the ScriptIQ system 100 has a tailored a physician-specific communication. This way, physicians do not need to read through the regular mailed updates received from various users (e.g., pharmaceutical companies), but may efficiently received information that directly affects the prescribing habits of these physicians. For example, if a drug has been recalled by a pharmaceutical company which is presently in one of the eScriptPad prescription pads of the a physician, using the Rx Alert Service, that physician is ultimately informed that a drug that he usually prescribes is no longer valid or efficacious. This thus alerts the physician to not prescribe this now recalled drug and to order a new set of eScriptPad prescription pads. Depending on the model and implementation, a medical group administrator may be an intervening user of such communication. See FIG. 17 for an exemplary representation of an alert communication based on information received from a pharmaceutical company.

Considering that physicians are very busy people, in one embodiment, the ScriptIQ system notifies the MGA of an MG about the alert condition 1604, e.g., a drug from a pharmaceutical company has been recalled. This notification from the ScriptIQ system, in one embodiment, is tailored such that it notifies the MGA of the names (or email addresses) of physicians whose eScriptPad prescription pads are affected. This is done by the Rx Alert Service by querying the RxIQ Datamart to determine which physicians have in their formulary this now-recalled pharmaceutical product. The email may also contain relevant information, for example, received from the pharmaceutical company, informing why such drug has been recalled. Links to appropriate web sites may also be included.

In the next operation 1606, the MGA updates the eScriptPad prescription pads of the affected physicians by creating a new formulary or eScriptPad prescription pad. In one embodiment, this may be done automatically by the ScriptIQ system.

Next 1608, the MGA notifies the affected physicians to approve the proposed revised eScriptPad prescription pads. To approve the proposed new eScriptPad prescription pads, the physician logs into the Prescriber Portal 1610, for example, by supplying the proper user name and password. A web page, for example, shown in FIG. 9 is then presented to the physician for review. Within the Prescriber Portal, the physician may also make changes to the proposed prescription pads and create new ones, if necessary.

If the physician is satisfied with the new eScriptPad prescription pad(s), the physician approves the eScriptPad prescription pads created in the next operation 1612, typically using the Prescriber Portal. One or more eScriptPad prescription pads are then created. In one embodiment, proofs in PDF format are created.

One skilled in the art will understand that variations in the process flow in FIG. 16 exist, e.g., notification instead of being sent to the MGA first are automatically sent to the affected physicians, revisions to existing eScriptPad prescription pads may also be automatically generated by the ScriptIQ system, operations done by the MGA may be skipped and/or automatically done by the ScriptIQ system, and the like.

FIG. 17 is an exemplary representation of an alert communication based on information received from a pharmaceutical company sent by the Rx Alert Service 250 to a medical group administrator.

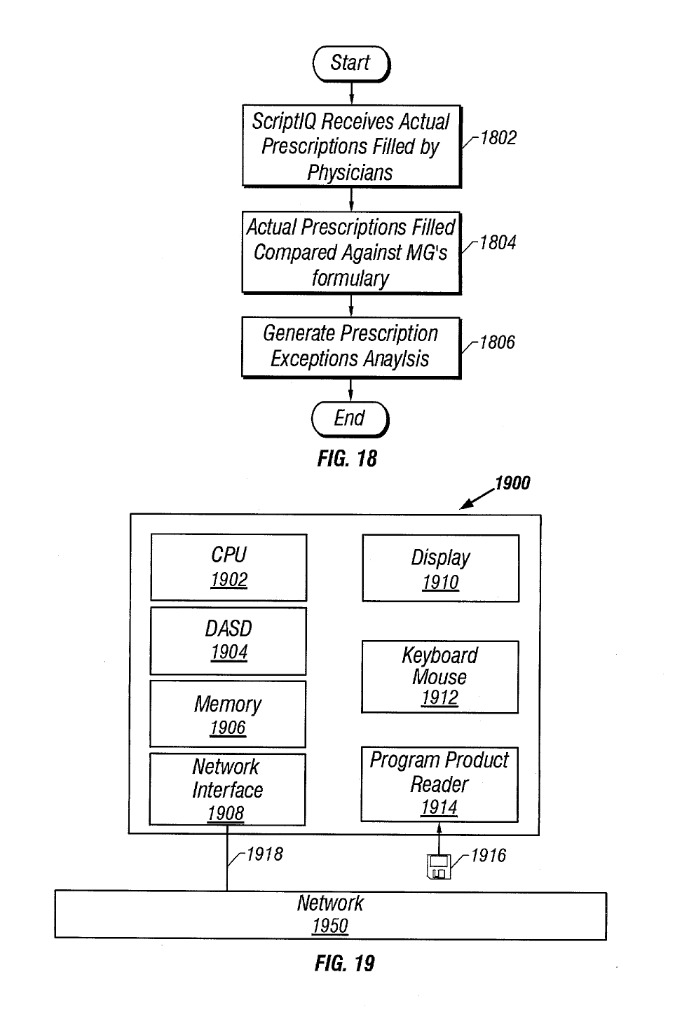

FIG. 18 is a basic block diagram of how the DecisionIQ Prescription Analyzer may be used to generate a prescription exception report. In the first operation 1802, the ScriptIQ server 100 receives actual prescriptions filled information (usually obtained from third parties). This information is loaded into the RxIQ datamart by various mechanisms. In one embodiment, the information is provided in table format and uploaded to the RxIQ Datamart. In the next operation 1804, the actual prescriptions filled (i.e., prescribed by physicians within the medical group) are compared against the MG formulary, which is obtained or queried from the RxIQ Datamart. Drugs that were prescribed but not within the MG formulary are identified. This way, a prescription exception analysis report may be generated. This report thus may be used by the MG to see a list of physicians who are not in compliance with the formulary of the MG.

The primary benefits of the Script IQ system in general are listed in the table below.

| RESULTS | BENEFITS |
|---|---|
| Increased Formulary Compliance | Lower Costs for MCOs, Physician Groups |
| | & Patients. Reduce pharmacy callbacks. |
| Reduced Errors from Illegible | Improved Patient Safety/Reduced Costs |
| Handwriting & Like-Sounding Drugs | Due to Less-Frequent Hospitalization and |
| | Lower Malpractice Premiums |
| Access to Products and Services at One | Fast Re-order of Supplies and Drug |
| Complete “Medication Management” | Samples, and a Trusted Site as a Platform |
| Location | for Future Products and Services. |
| An Effective Communication Channel | Enhanced Communication with All |
| (Helps to Eliminate Mail & Phone Calls) | Healthcare Stakeholders. Save time and |
| | money. Reduce administrative costs. |
| Dramatically Reduced Prescription Fraud | The DEA's #2 Problem—At a Cost of $25 |
| | Billion Annually |

In one embodiment of the business model, i.e., the standard service level configuration, the Script IQ solution delivers medical group physicians or providers value and benefits such as: (1) An effective tool for ongoing formulary updates, improving compliance, and reducing pharmaceutical costs; (2) Clean, legible, error, and possibly fraud-proof prescriptions, which reduce administrative burden and improve patient safety; (3) Near real-time communication to physicians for formulary changes, drug recall alerts, education, and more; and (4) A trusted source for all medication management-related information.

The Script IQ solution can also be configured with a premium service level of functionality for medical group administrators. In addition to the standard features, this product will allow medical groups to have: (1) Administrative access and control of Prescriber Portal elements; (2) Ability to manage/modify the physician user experience and the eScriptPad prescription pad to maintain group-wide formulary control, and manage to flow of outside information from stakeholders to physicians; (3) A mechanism for near real-time communication between medical group administrators and physicians; (4) Access to group-level and physician-specific prescription utilization reporting functionality for profiling and prescribing behavior modification programs; and (5) Group-specific co-branding on the Prescriber Portal and eScriptPad prescription pads.

Revenue

Adoption is key for success, as the revenues for Script IQ will be driven by those stakeholders attempting to effectively communicate with prescribing physicians. The Prescriber Portal will facilitate two-way communication and connectivity to all important stakeholders concerned with managing the prescribing process, and its resulting cost and outcomes, namely: the medical groups, MCOs and the pharmaceutical manufacturers.

In deploying the invention of the present invention, revenues may be obtained from various subscribers who wish to effectively communicate with prescribing physicians. The Prescriber Portal, for example, facilitates two-way communication and connectivity to all important users concerned with managing the prescribing process, and its resulting cost and outcomes, namely: the medical groups, MCOs and the pharmaceutical manufacturers. In one embodiment of the Script IQ model, all revenue sources will key off of the number of physician users. Although the standard services will be offered to physicians at no charge, Script IQ model derives its revenues through a partnering model, with various groups such as MCO's or insurance groups and pharmaceutical companies.

In one embodiment, the company deploying the Script IQ system may charge $50 per-physician, per-month to MCOs to support their affiliated physicians' use of the ScriptIQ eScriptPad product and access to the Prescriber Portal two-way communication solution. The rationale used to arrive at this figure was based upon the average prescription utilization amongst managed care patients and average managed care penetration within physician patient panels. By attaching a $.50 per-prescription charge on the value of the ScriptIQ solution being brought to the MCOs, and considering that 80% of a typical physician's 6,000 prescriptions are managed care oriented, this represents a $200 per physician, per-month opportunity. Consequently, a modest $50 per-physician, per-month fee is a fair value.

As part of the partnering model of the Script IQ marketing strategy, the applicants view the medical group as one of the key influencers and drivers of the adoption of the ScriptIQ solution. For example, over half of all practicing physicians today are in medical groups or affiliated with contracting associations, such as IPAs (Independent Practice Associations). Of these, nearly 41% indicated that their physicians took on at least some risk for pharmacy expenditures. Managed Care Digest Series-Medical Group Practice Digest, Hoechst Marion Roussel, 1999. This means that while the physicians can be monetarily incentivized for appropriately managing their pharmacy costs, they can also be penalized (by the MCOs with whom they are contracted) if they go over their budgeted per-patient amount. In reality, very few groups ever come in under their budgeted amount for pharmacy-most exceed their budget and have to pay the MCOs as a result of their inability to manage drug spend. Therein lies the “risk,” and a compelling reason for medical groups to embrace the Script IQ solution as an effective medication management tool.

In addition, there are medical/legal advantages to utilizing the fraud-proof, pre-printed eScriptPad prescription pad. The eScriptPad prescription pad will help reduce medical errors, thereby increasing patient safety and minimizing group risk from a malpractice perspective. One research indicates that malpractice insurers may offer premium discounts to doctors that are proactively working to reduce errors and fraud.

In one embodiment, e.g., premium level of functionality (described above), Script IQ will charge medical groups a one-time set-up fee of $200 per physician. In addition, Script IQ will charge the medical group a nominal $20 per-physician, per-month maintenance fee.

The Script IQ solution described herein is less revolutionary, and more evolutionary-designed to bridge the gap between the antiquated processes of today and the sophisticated technology that, from a wide-scale adoption standpoint, may be the healthcare model of tomorrow. It offers powerful information and solutions without requiring a wholesale change in the way medicine is practiced. As a result, it is believed that Script IQ solution or system can address the fragmentation of pharmaceutical-related information today, and that its web-based system, embodied in the Prescriber Portal, will become the primary service that physicians, medical groups, payers and pharmaceutical manufacturers will embrace and use to coordinate all aspects of clinical pharmaceutical information, communication and medication management.

FIG. 19 is a block diagram of a computer that may be used to implement the ScriptIQ system described herein. The ScriptIQ system may be deployed in a single computer, or may be deployed in conjunction with one or more computers that may communicate with each other over a network to share data. Those skilled in the art will appreciate that the features described above may be implemented with one or more computers, all of which may have a similar computer construction to that illustrated in FIG. 19, or may have alternative constructions consistent with the capabilities or features described herein.

FIG. 19 shows an exemplary computer 1900 such as might comprise a computer, which supports the ScriptIQ server, to enable the features described above, and to permit the various display and computer processing operations. Each computer 1900 operates under control of a central processor unit (CPU) 1902, such as a “Pentium” microprocessor and associated integrated circuit chips, available from Intel Corporation of Santa Clara, Calif., USA. A computer user can input commands and data from a keyboard and computer mouse 1912, and can view inputs and computer output at a display 1910. The display is typically a video monitor or flat panel display. The computer 1900 also includes a direct access storage device (DASD) 1904, such as a hard disk drive. The memory 1906 typically comprises volatile semiconductor random access memory (RAM). Each computer preferably includes a program product reader 1914 that accepts a program product storage device 1916, from which the program product reader can read data (and to which it can optionally write data). The program product reader can comprise, for example, a disk drive, and the program product storage device can comprise removable storage media such as a magnetic floppy disk, a CD-R disc, a CD-RW disc, or DVD disc.

The computer 1900 can communicate with other computers over a computer network 1918 (such as the Internet or an intranet) through a network interface 1908 that enables communication over a connection 1918 between the network 1950 and the computer 1900. The network interface 1908 typically comprises, for example, a Network Interface Card (NIC) or a modem that permits communications over a variety of networks. The CPU 1902 operates under control of programming steps that are temporarily stored in the memory 1906 of the computer 1900. When the programming steps are executed, the computer performs its functions. Thus, the programming steps implement the functionality of the ScriptIQ system described above. The programming steps can be received from the DASD 1904, through the program product storage device 1916, or through the network connection 1950. The program product storage drive 1916 can receive a program product 1916, read programming steps recorded thereon, and transfer the programming steps into the memory 1906 for execution by the CPU 1902. As noted above, the program product storage device can comprise any one of multiple removable media having recorded computer-readable instructions, including magnetic floppy disks and CD-ROM storage discs. Other suitable program product storage devices can include magnetic tape and semiconductor memory chips. In this way, the processing steps necessary for operation in accordance with the invention can be embodied on a program product.

Alternatively, the program steps can be received into the operating memory 1906 over the network 1918. In the network method, the computer receives data including program steps into the memory 1906 through the network interface 1908 after network communication has been established over the network connection 1950 by well-known methods that will be understood by those skilled in the art without further explanation. The program steps are then executed by the CPU 1902 thereby comprising a computer process. It should be understood that the any device that supports the features described above will typically have a construction similar to that shown in FIG. 19, so that details described with respect to the FIG. 19 computer 1900 will be understood to apply to all computers of any network system in which the ScriptIQ system may be deployed. Alternatively, the devices can have an alternative construction, so long as the computer can communicate with the other computers and can support the functionality described herein.

One skilled in the art should readily appreciate that the present invention is well adapted to carry out the benefits and advantages mentioned, as well as those inherent therein. The specific embodiments described herein as presently representative of preferred embodiments are exemplary and are not intended as limitations on the scope of the invention. Steps may be automated skipping some operations described herein. In addition, functions, for example, done by the MGA may be done by other users, such as by the physician themselves. Changes therein and other uses will occur to those skilled in the art which are encompassed within the spirit of the invention are defined by the scope of the claims. It will be readily apparent to one skilled in the art that modifications may be made to the invention disclosed herein without departing from the scope and spirit of the invention.

The present invention has been described above in terms of presently preferred embodiments so that an understanding of the present invention can be conveyed. There are, however, many configurations for a ScriptIQ system not specifically described herein but with which the present invention is applicable. The present invention should therefore not be seen as limited to the particular embodiments described herein, but rather, it should be understood that the present invention has wide applicability with respect to information systems generally. All modifications, variations, or equivalent arrangements and implementations that are within the scope of the attached claims should therefore be considered within the scope of the invention.

We claim:

1. A method of providing medical prescription service, the method comprising:
receiving a formulary for a physician wherein said formulary is stored in a data store;
generating a personalized physician-specific prescription pad using said received formulary.

2. A method as defined in claim 1 wherein said received formulary for said physician may take into account the physician's prescribing habits, the formularies of managed care organizations (MCOs) across the physician's patient base, the drugs within the MCO formulary which are likely to be approved by the MCO, and the formulary of the medical groups to which the physician belongs.

3. A method as defined in claim 1, further comprising:
providing a preview of said prescription pad.

4. A method as defined in claim 3, wherein the preview of said prescription pad is provided over a computer network connection.

5. A method as defined in claim 1, wherein said formulary is received over a computer network data connection.

6. A method as defined in claim 1, further comprising:
sending a message informing a user of said generation of said prescription pad.

7. A method as defined in claim 6, further comprising:
receiving approval of said generated personalized prescription pad.

8. A method as defined in claim 1, further comprising:
receiving an alert-triggering information that relates to the formulary listed in said generated prescription pad.

9. A method as defined in claim 8, further comprising:
sending alert communication to a user based on said alert-triggering information.

10. A method as defined in claim 9 wherein said alert communication indicates that said personalized prescription pad previously generated for said physician has to be updated.

11. A method as defined in claim 8, further comprising:
creating a new personalized prescription pad for said physician based on said alert-triggering information.

12. A method as defined in claim 1, further comprising:
receiving a formulary for a medical group (MG formulary) wherein said MG formulary is stored in a data store;
receiving physician information for said physician within said medical group wherein said physician information is stored in a data store; and
wherein said received formulary for said physician from which said personalized prescription pad is generated is based on said MG formulary, including user revisions, if any, and based on said physician information, including said physician's practice area.

13. A method as defined in claim 12, further comprising:
receiving an alert-triggering information.

14. A method as defined in claim 13, wherein said alert-triggering information is a change to said formulary from said medical group.

15. A method as defined in claim 13, further comprising:
sending alert communication to a user based on said alert-triggering information.

16. A method as defined in claim 12, further comprising:
receiving formulary for at least one MCO and storing said MCO formulary in a data store; and
determining an MG formulary based on MCO formularies, including user revisions, if any,
and wherein said received MG formulary is based on said determined MG formulary.

17. A method as defined in claim 12, further comprising:
receiving actual prescription filled information for said physician; and
generating a prescription analysis for said physician.

18. A computer system that provides medical prescription services to physicians, the system comprising:
an RxIQ Datamart that stores, processes, collects, and combines formulary information, including formulary for physicians, medical groups, and managed care organizations, and user information.
a Prescriber Portal that enables users to provide formularies and physician-specific information, including prescribing habits, that are then stored in said RxIQ Datamart; and
an eScriptPad Configurator that creates personalized physician-specific prescription pad called eScriptPad based on formularies and physician-specific information available.

19. A system as defined in claim 18, wherein the eScriptPad Configurator enables a user to preview the eScriptPad prescription pad and enables revisions and inputs to said prescription pad.

20. A system as defined in claim 19, wherein the preview of eScriptPad prescription pad is provided over a computer network connection.

21. A system as defined in claim 19, wherein the user input and revisions are received over a computer network data connection.

22. A system as defined in claim 18, further comprising:
an Rx Alert Service that receives alert-triggering information and sends alert-triggering communication to the appropriate user.

23. A system as defined in claim 22, wherein said alert-triggering communication indicates that an eScriptPad prescription pad created by said eScriptPad Configurator needs to be updated.

24. A system as defined in claim 18, further comprising:
a DecisionIQ Prescription Analyzer that processes information retrieved from the RxIQ Datamart and generates reports.

25. A system as defined in claim 24, wherein said report is a prescription exception report.

26. A computer system that provides medical prescription services to physicians, the system comprising:
a computing means that receives input from network nodes;
a store and processing means that stores, processes, collects, and combines formulary information, including formulary for physicians, medical groups, and managed care organizations, and user information.
an input receiving means that enables users to provide formularies and physician-specific information, including prescribing habits, that are then stored in said RxIQ Datamart; and
a pad configuration means that creates personalized physician-specific prescription pad called eScriptPad based on formularies and physician-specific information available.

27. A physician-specific prescription pad based from a process in which a formulary for a physician is received and wherein said formulary takes into account the physician's prescribing habits, the formularies of managed care organizations (MCOs) across the physician's patient base, the drugs within the MCO formulary which are likely to be approved by the MCO, and the formulary of the medical groups to which the physician belongs.
